(19) United States
(12) Patent Application Publication
(10) Pub. No.: US 2014/0008297 A1
(43) Pub. Date: Jan. 9, 2014

(54) SEPARATION METHOD AND SEPARATION DEVICE

(71) Applicant: Kabushiki Kaisha Koba Seiko Sho (Kobe Steel Ltd.), (US)

(72) Inventors: Akira Matsuoka, Kobe-shi (JP); Koji Noishiki, Takasago-shi (JP)

(73) Assignee: Kabushiki Kaisha Koba Seiko Sho (Kobe Steel, Ltd.), Kobe (JP)

(21) Appl. No.: 13/862,145

(22) Filed: Apr. 12, 2013

(30) Foreign Application Priority Data
Jul. 5, 2012 (JP) 2012-151603

(51) Int. Cl. B01D 11/04

(52) U.S. Cl. CPC B01D 11/0484; B01D 11/0496
USPC 210/634; 210/137

(57) ABSTRACT

A separation method performs steps continuously and leads a solvent in which a separation object component is dissolved and a remaining fluid out of settlers under a separated state. The method includes leading a light fluid with a smaller specific gravity within the fluid in which the specific component is dissolved at the dissolution step and the remaining fluid out of settlers through upper side leading paths, and leading a heavy fluid with a larger specific gravity within the fluid in which the specific component is dissolved and the remaining fluid out of the settlers through lower side leading paths. A flow rate of the light fluid is controlled such that the height position of an interface between the light fluid and the heavy fluid within the settlers is maintained between the height position of connection parts of the upper side leading paths and the height position of connection parts of the lower side leading paths to the settlers.

### BACKGROUND OF THE INVENTION

1. Field of the Invention

The present invention relates to a separation method and a separation device for separating a specific component from the object fluid by dissolving the specific component in a solvent from the object fluid containing the specific component.

2. Description of the Related Art

Conventionally, a variety of separation methods for separating a specific component from the object fluid are known, and an example of the separation methods is shown in a non-patent literature Soko ga Shiritai Kagaku no Hanashi (That's the Chemical Topic We Want to Know) “Bunri Gijutsu (Separation Technology)”', The Nikkan Kogyo Shimbun, Ltd., the publication of the first impression of the first edition on Jun. 28, 2008, p. 103.

Concretely, in the above non-patent literature, as an example of the separation methods, an extraction method for extracting a target component by a solvent from a stock solution which is an object fluid is disclosed. The extraction method disclosed in the non-patent literature is a multistage extraction performing repeatedly a single extraction by means of a device combining a plurality of mixers (agitation tanks) and a plurality of settlers. Specifically, in the extraction method, the stock solution and the solvent are agitated and mixed for extraction in a first stage mixer, and a mixture liquid of the stock solution and the solvent is introduced into a first stage settler and separated by a specific gravity difference into an extracted liquid comprising the solvent in which the target component is dissolved and an extracted residual liquid which is a remaining liquid lowered in the content of the target component within the settler. To the first stage settler, an upper side leading path and a lower side leading path are connected separately at an upper and a lower part, and the extracted liquid is led out of the settler through the upper side leading path and the extracted residual liquid is led out of the settler through the lower side leading path. Then, the extracted residual liquid is introduced into a second stage mixer and a new solvent is introduced into the mixer, and they are agitated and mixed for another extraction. The mixture liquid mixed in the second stage mixer is introduced into a second stage settler and separated into an extracted liquid and an extracted residual liquid as with the first stage. These agitation mixing by mixers and separation by settlers are performed repeatedly.

However, in a separation method such as the above-mentioned extraction method, it is difficult to perform steps continuously and to lead the solvent (extracted liquid) in which the target component is dissolved and the remaining liquid (extracted residual liquid) out of the settlers surely without mutually contaminating. The reasons are as follows.

In the above-mentioned method, since agitation mixing is performed in the mixer, the solvent in which the target component is dissolved and the remaining liquid come into a hardly separable state like emulsion. Therefore, it takes time to perform subsequent liquid separation in the settlers, and it becomes difficult to perform the steps continuously. Moreover, in the above-mentioned method, in a case where a supply flow rate of the stock solution varies depending on the operation state or the like of the device, the height position of an interface between the extracted liquid and the extracted residual liquid within the settlers fluctuates, and therefore there is fear that one of the extracted liquid and the extracted residual liquid is contaminated with the other and led out of the settlers.

### SUMMARY OF THE INVENTION

The present invention is thus achieved to solve the above-mentioned problem, and has an object to perform steps in a separation method continuously and to lead a solvent in which a component to be a separation object is dissolved and a remaining fluid out of settlers under a surely separated state.

In order to accomplish the above-mentioned object, it is conceivable that the settlers are increased in size, for example. In this case, even if the fluid agitated and mixed in the mixers comes into a hardly separable state such as emulsion, a large-capacity settler can absorb the time required for separation of the fluid, and sometime after the startup of a device for separation, the remaining fluid can be continuously fed to a succeeding stage side. Therefore, the steps can be continuously performed. Moreover, if the settlers are increased in size, the allowable width of a fluctuation in the height position of the interface between the solvent in which the target component is dissolved and the remaining fluid within the settlers is increased, so that two fluids led out of the settlers can be prevented from being mutually contaminated even when the height position of the interface fluctuates along with a variation in the supply flow rate of the stock solution. Therefore, the solvent in which the component to be a separation object is dissolved and the remaining fluid can be led out of the settlers under a surely separated state.

However, if the settlers are increased in size, the whole device for separation is also increased in size and the device is subjected to the restriction of the installation space.

Thus, the present inventor invented the following separation method and separation device in order to solve these problems. A separation method according to the present invention for separating a specific component from the object fluid by dissolving the specific component in a solvent from the object fluid containing the specific component, comprising the steps of; dissolving the specific component in the solvent from the object fluid within microchannels by feeding the object fluid and the solvent in a state of a slag flow or a two-layer flow to the microchannels; introducing the fluid discharged from the microchannels into the settlers and separating the fluid into a fluid comprising the solvent in which the specific component is dissolved and a remaining fluid by a specific gravity difference within the settlers; leading a light fluid which is one fluid with a smaller specific gravity among the fluid in which the specific component is dissolved and the remaining fluid out of the settlers through upper side leading paths connected to the settlers and leading a heavy fluid which is one fluid with a larger specific gravity among the fluid in which the specific component is dissolved and the remaining fluid out of the settlers through lower side leading paths connected to the settlers at a position lower than connection parts of the upper side leading paths to the settlers; and controlling at least one flow rate of a flow rate of the light fluid led out of the settlers to the upper side leading paths and a flow rate of the heavy fluid led out of the settlers to the lower side leading paths such that the height position of an interface between the light fluid and the heavy fluid within the settlers is maintained between the height position of the connection parts of the upper side leading paths to the settlers and the height position of connection parts of the lower side leading paths to the settlers.

In the above separation method, since the object fluid and the solvent are fed in the state of the slag flow or the two-layer flow to the microchannels at the dissolution step, the fluid introduced into the settlers from the microchannels can be separated into the fluid comprising the solvent in which the specific component is dissolved and the remaining fluid in a short time at the subsequent separation step. Concretely, when the object fluid and the solvent are fed in the state of the slag flow or the two-layer flow to the microchannels, the solvent in which the specific component of the object fluid is dissolved and the remaining fluid are fed in the state of the slag flow or the two-layer flow and introduced into the settlers from the microchannels. The state of the slag flow or the two⁻layer flow is a state that the solvent in which the specific component is dissolved and the remaining fluid are relatively separated from each other, and therefore the fluid introduced into the settlers can be separated into the solvent in which the specific component is dissolved and the remaining fluid in a short time, compared with the case of agitating and mixing the fluid in a conventional agitation tank. Therefore, the steps can be continuously performed without increasing the settlers in size. Moreover, in the separation method, the height position of the interface between the light fluid and the heavy fluid within the settlers is maintained at the height position between the connection parts of the upper side leading paths and the connection parts of the lower side leading paths to the settlers by flow rate control of the fluid led out of the settlers, and therefore it is possible to prevent one of the light fluid and the heavy fluid from being contaminated with the other and being led out of the settlers to the upper side leading paths or the lower side leading paths even if the supply flow rate of the object fluid is changed. That is, the solvent in which the specific component is dissolved and the remaining fluid can be surely separated in the settlers and led out. Then, since the light fluid and the heavy fluid led out of the settlers can be prevented from being mutually contaminated by the flow rate control as thus described, it is not necessary to increase the settlers in size in order to secure the allowable width for the fluctuation in the height position of the interface between the light fluid and the heavy fluid within the settlers when the flow rate of the object fluid varies. Even from this viewpoint, the settlers can be decreased in size, and thus a device for use in the separation method can be decreased in size.

In the above-mentioned separation method, a separation operation including the dissolution step, the separation step, the leading step, and the flow rate control step is repeatedly performed a plurality of times, and then in the dissolution step of the succeeding stage separation operation among the plurality of separation operations, it is preferable that the fluid corresponding to the remaining fluid among the light fluid led out to the upper side leading path and the heavy fluid led out to the lower side leading path at the leading step of the previous separation operation is fed to the microchannel as the object fluid and the specific component remaining in the fluid is dissolved in the solvent.

According to the above configuration, the efficiency of elution can be improved by dissolving the specific component within the object fluid in a relatively fresh solvent in each dissolution step of each separation operation. Therefore, a total time to be required for separation of the specific component from the object fluid can be shortened.

In this case, in the separation step of the specific separation operation among the plurality of separation operations, it is preferable that the fluid corresponding to the fluid in which the specific component is dissolved among the light fluid led out to the upper side leading path and the heavy fluid led out to the lower side leading path at the leading step of the following separation operation is fed to the microchannel as the solvent.

According to the above configuration, since the solvent in which the specific component was dissolved at the dissolution step of the specific separation operation can be reused as the solvent at the dissolution step of the preceding stage separation operation, the amount of the solvent used can be reduced. Moreover, in the above configuration, at the dissolution step of the preceding stage separation operation, while the solvent in which the specific component was dissolved at the dissolution step of the succeeding stage separation operation is used, the amount of the specific component dissolved in the solvent at the succeeding stage separation operation is relatively small, so that such a solvent is sufficiently usable for eluting the specific component from the preceding stage object fluid having a relatively high content of the specific component. Therefore, at the dissolution steps of the respective stage separation operations, the necessary elution action of the specific component from the object fluid into the solvent can be secured.

In addition, a separation device according to the present invention for separating a specific component from the object fluid by dissolving the specific component in a solvent from the object fluid containing the specific component, comprising: microchannels for feeding the object fluid and the solvent in a state of a slag flow or a two-layer flow and dissolving the specific component in the solvent from the object fluid; settlers connected to the microchannels so as to introduce the fluid discharged from the microchannels therein for separating the fluid discharged from the microchannels into a fluid comprising the solvent in which the specific component is dissolved and a remaining fluid by a specific gravity difference; upper side leading paths connected to the settlers for leading a light fluid which is one fluid with a smaller specific gravity among the fluid in which the specific component is dissolved and the remaining fluid out of the settlers; lower side leading paths connected to the settlers at a position lower than connection parts of the upper side leading paths to the settlers for leading a heavy fluid which is one fluid with a larger specific gravity among the fluid in which the specific component is dissolved and the remaining fluid out of the settlers; and a flow rate control device for controlling at least one flow rate of a flow rate of the light fluid led out of the settlers to the upper side leading paths and a flow rate of the heavy fluid led out of the settlers to the lower side leading paths such that the height position of an interface between the light fluid and the heavy fluid within the settlers is maintained between the height position of the connection parts of the upper side leading paths to the settlers and the height position of connection parts of the lower side leading paths to the settlers.

In the above separation device, as with the above-mentioned separation method, the steps can be continuously performed, and the separation device can be decreased in size while allowing the solvent in which the specific component to be a separation object is dissolved and the remaining fluid to be led out of the settlers under a surely separated state.

As discussed above, according to the present invention, steps in a separation method can be continuously performed, and a separation device for use in the separation method can be decreased in size while allowing a solvent in which a component to be a separation object is dissolved and a remaining fluid to be led out of settlers under a surely separated state.

### BRIEF DESCRIPTION OF THE DRAWINGS

FIG. 1 is a schematic diagram showing a configuration of an extraction device for use in an extraction method according to a first embodiment of the present invention.

FIG. 2 is a schematic diagram showing fluids flowing through microchannels in a state of a slag flow in the extraction method according to the first embodiment.

FIG. 3 is a schematic diagram showing fluids flowing through the microchannels in a state of a two-layer flow in the extraction method according to the first embodiment.

FIG. 4 is a schematic diagram showing a configuration of an extraction device for use in an extraction method according to a second embodiment of the present invention.

FIG. 5 is a schematic diagram showing a configuration of an extraction device for use in an extraction method according to a third embodiment of the present invention.

### DESCRIPTION OF THE PREFERRED EMBODIMENTS

Hereinafter, embodiments of the present invention will be described with reference to the drawings.

### First Embodiment

First, as a first embodiment of a separation method of the present invention, an extraction method for extracting a specific component from the object fluid by dissolving the specific component in a solvent from the object fluid will be described.

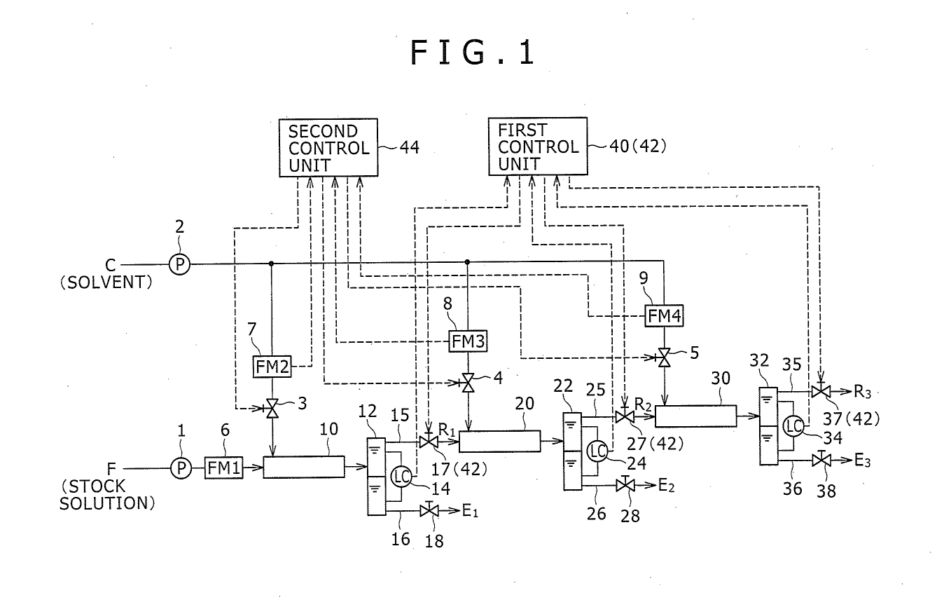

In the extraction method according to the first embodiment, extraction is performed with the use of an extraction device configured as shown in FIG. 1. The extraction device is included in the concept of “separation device” of the present invention. The extraction device comprises a first supply pump 1, a second supply pump 2, a first solvent flow rate regulating valve 3, a second solvent flow rate regulating valve 4, a third solvent flow rate regulating valve 5, a first flow meter 6, a second flow meter 7, a third flow meter 8, a fourth flow meter 9, a first microchannel 10, a first settler 12, a first liquid level gauge 14, a first upper side leading path 15, a first lower side leading path 16, a first upper side valve 17, a first lower side valve 18, a second microchannel 20, a second settler 22, a second liquid level gauge 24, a second upper side leading path 25, a second lower side leading path 26, a second upper side valve 27, a second lower side valve 28, a third microchannel 30, a third settler 32, a third liquid level gauge 34, a third upper side leading path 35, a third lower side leading path 36, a third upper side valve 37, a third lower side valve 38, a first control unit 40, and a second control unit 44. The extraction device is configured so as to be able to perform three stage extraction operations.

The first supply pump 1 is used to supply a stock solution (the object fluid) containing a specific component to be an extraction object in a first stage extraction operation, and the second supply pump 2 is used to supply a solvent (an extraction solvent) for dissolving the specific component and extracting it from the stock solution in the respective stage extraction operations.

The first microchannel 10 is a minute flow path having an equivalent diameter of several millimeters or less, and supplies the joined fluid of the stock solution and the solvent in a state of a slag flow or a two-layer flow for dissolving the specific component in the solvent from the stock solution and extracting it in the first stage extraction operation.

To the inlet side of the first microchannel 10, the first supply pump 1 and the second supply pump 2 are connected through piping respectively. The piping connecting the first supply pump 1 and the first microchannel 10 is provided with the first flow meter 6. The first flow meter 6 detects a flow rate of the stock solution to be supplied (discharged) from the first supply pump 1 to the first microchannel 10. In addition, the piping to which the second supply pump 2 is connected branches into three, and one of the branched piping (branch pipes) is connected to the first microchannel 10. The branch pipe connected to the first microchannel 10 is provided with the second flow meter 7 and the first solvent flow rate regulating valve 3. The second flow meter 7 detects a flow rate of the solvent to be supplied (discharged) from the second supply pump 2 to the first microchannel 10. The second flow meter 7 is electrically connected to the second control unit 44 and sends data of the detected flow rate of the solvent to the second control unit 44. The first solvent flow rate regulating valve 3 is used to set the flow rate of the solvent to be supplied to the first microchannel 10. The first solvent flow rate regulating valve 3 is electrically connected to the second control unit 44, and its opening is set according to a control signal from the second control unit 44, thereby setting the flow rate of the solvent to be supplied to the first microchannel 10 to a set flow rate.

The first microchannel 10 is configured so as to join the stock solution supplied from the first supply pump 1 and the solvent supplied from the second supply pump 2 in the interior thereof. The outlet side of the first microchannel 10 is connected to the first settler 12. The first settler 12 is a separation tank for separating the joined fluid discharged from the first microchannel 10 into an extracted liquid and an extracted residual liquid by a specific gravity difference. It should be noted that the extracted liquid is the solvent after eluting the specific component from the stock solution and extracting it. Moreover, the extracted residual liquid is a remaining fluid other than the extracted liquid among the joined fluid, and corresponds to the stock solution from which a certain amount of the specific component has been extracted by the solvent.

The first liquid level gauge 14 is attached to the first settler 12. The first liquid level gauge 14 detects the height position of an interface between the extracted liquid and the extracted residual liquid within the first settler 12. The first liquid level gauge 14 is electrically connected to the first control unit 40 and sends data of the detected height position of the interface to the first control unit 40.

To the first settler 12, the first upper side leading path 15 and the first lower side leading path 16 are connected. The upper side leading path 15 is connected to the upper part of the first settler 12, and the first lower side leading path 16 is connected to the first settler 12 at a position lower than a connection part of the first upper side leading path 15 to the first settler 12. That is, the first lower side leading path 16 is connected to the lower part of the first settler 12 separated downward from the connection part of the first upper side leading path 15. In the first settler 12, a light fluid which is one fluid with a smaller specific gravity among the extracted liquid and the extracted residual liquid floats on the upper side, and a heavy fluid which is one fluid with a larger specific gravity among them sinks on the lower side. Thus, to the first upper side leading path 15, the light fluid is led out of the first settler 12, and to the first lower side leading path 16, the heavy fluid is led out of the first settler 12.

The first upper side leading path 15 is provided with the first upper side valve 17 for controlling the flow rate of the light fluid to be led out of the first settler 12 to the first upper side leading path 15, and the first lower side leading path 16 is provided with the first lower side valve 18 for controlling the flow rate of the heavy fluid to be led out of the first settler 12 to the first lower side leading path 16. These valves 17, 18 are electromagnetic control valves. The first upper side valve 17 is electrically connected to the first control unit 40, and its opening is controlled according to a control signal from the first control unit 40, thereby controlling the flow rate of the light fluid flowing to the first upper side leading path 15.

By the above-mentioned first supply pump 1, second supply pump 2, first solvent flow rate regulating valve 3, first flow meter 6, second flow meter 7, first microchannel 10, first settler 12, first liquid level gauge 14, first upper side leading path 15, first lower side leading path 16, first upper side valve 17, and first lower side valve 18, a section to perform the first stage extraction operation is configured. A section to perform a second stage extraction operation and a section to perform a third stage extraction operation are basically configured similarly to the first stage one.

The section to perform the second stage extraction operation is configured by the second supply pump 2, the second solvent flow rate regulating valve 4, the third flow meter 8, the second microchannel 20, the second settler 22, the second liquid level gauge 24, the second upper side leading path 25, the second lower side leading path 26, the second upper side valve 27, and the second lower side valve 28.

To the inlet side of the second microchannel 20, an end part on the downstream side of the first upper side leading path 15 is connected and the second supply pump 2 is connected through the piping. One of the branch pipes of the piping to which the second supply pump 2 is connected is connected to the second microchannel 20, and the branch pipe is provided with the third flow meter 8 and the second solvent flow rate regulating valve 4. The second supply pump 2 supplies a new solvent to the second microchannel 20, and the third flow meter 8 detects a flow rate of the solvent. Moreover, the second solvent flow rate regulating valve 4 whose opening is set by the second control unit 44 sets the flow rate of the solvent to be supplied to the second microchannel 20. The configuration concerning the third flow meter 8, the second solvent flow rate regulating valve 4, and the second control unit 44 is similar to the above-mentioned configuration concerning the second flow meter 7, the first solvent flow rate regulating valve 3, and the second control unit 44.

Into the second microchannel 20, the extracted residual liquid corresponding to the light fluid separated in the first settler 12 is introduced through the first upper side leading path 15, and in order to dissolve the specific component remaining in the extracted residual liquid in the solvent from the extracted residual liquid and extract it, the joined fluid of the extracted residual liquid and the new solvent is fed in a state of a slag flow or a two-layer flow. The other configuration of the second microchannel 20 is similar to the configuration of the first microchannel 10. Moreover, the configuration concerning the second settler 22, the second liquid level gauge 24, the second upper side leading path 25, the second lower side leading path 26, the second upper side valve 27, and the second lower side valve 28 is similar to the above-mentioned configuration concerning the first settler 12, the first liquid level gauge 14, the first upper side leading path 15, the first lower side leading path 16, the first upper side valve 27, and the first lower side valve 18.

The section to perform the third stage extraction operation is configured by the second supply pump 2, the third solvent flow rate regulating valve 5, the fourth flow meter 9, the third microchannel 30, the third settler 32, the third liquid level gauge 34, the third upper side leading path 35, the third lower side leading path 36, the third upper side valve 37, and the third lower side valve 38.

To the inlet side of the third microchannel 30, an end part on the downstream side of the second upper side leading path 25 is connected and the second supply pump 2 is connected through the piping. One of the branch pipes of the piping to which the second supply pump 2 is connected is connected to the third microchannel 30, and the branch pipe is provided with the fourth flow meter 9 and the third solvent flow rate regulating valve 5. The second supply pump 2 supplies a new solvent to the third microchannel 30, and the fourth flow meter 9 detects a flow rate of the solvent. Moreover, the third solvent flow rate regulating valve 5 whose opening is set by the second control unit 44 sets the flow rate of the solvent to be supplied to the third microchannel 30. The configuration concerning the fourth flow meter 9, the third solvent flow rate regulating valve 5, and the second control unit 44 is similar to the above-mentioned configuration concerning the second flow meter 7, the first solvent flow rate regulating valve 3, and the second control unit 44.

In addition, into the third microchannel 30, the extracted residual liquid corresponding to the light fluid separated in the second settler 22 is introduced through the second upper side leading path 25. The configuration concerning the third microchannel 30 is similar to the configuration concerning the second microchannel 20. In addition, the configuration concerning the third settler 32, the third liquid level gauge 34, the third upper side leading path 35, the third lower side leading path 36, the third upper side valve 37, and the third lower side valve 38 is similar to the configuration concerning the second settler 22, the second liquid level gauge 24, the second upper side leading path 25, the second lower side leading path 26, the second upper side valve 27, and the second lower side valve 28.

It should be noted that the first microchannel 10, the second microchannel 20, and the third microchannel 30 may be provided within different flow path structures respectively, or may be provided within the same flow path structure.

The first control unit 40 regulates openings of the first to third upper side valves 17, 27, 37 and controls the flow rate of the extracted residual liquid (light fluid) flowing to the first to third upper side leading paths 15, 25, 35. By the first control unit 40 and the first to third upper side valves 17, 27, 37, a flow rate control device 42 for controlling the flow rate of the extracted residual liquid (light fluid) led out of the respective settlers 12, 22, 32 to the respective upper side leading paths 15, 25, 35 is configured. The concrete contents of control by the first control unit 40 will be described later.

As described above, the second control unit 44 regulates the opening of the first solvent flow rate regulating valve 3 based on the data of the flow rate of the solvent detected by the second flow meter 7 and regulates the flow rate of the solvent supplied to the first microchannel 10 to the set flow rate, regulates the opening of the second solvent flow rate regulating valve 4 based on the data of the flow rate of the solvent detected by the third flow meter 8 and regulates the flow rate of the solvent supplied to the second microchannel 20 to the set flow rate, and regulates the opening of the third solvent flow rate regulating valve 5 based on the data of the flow rate of the solvent detected by the fourth flow meter 9 and regulates the flow rate of the solvent supplied to the third microchannel 30 to the set flow rate.

Next, the extraction method according to the first embodiment with the use of the extraction device such as the above will be concretely described hereinafter.

In the extraction method according to the first embodiment, firstly, to the first microchannel 10, the first supply pump 1 supplies the stock solution containing the specific component to be the extraction object and the second supply pump 2 supplies the solvent (extraction solvent). As the stock solution, organic solvent or the like such as dodecane containing phenol as the specific component to be the extraction object is used, for example, and as the solvent, water or the like is used, for example.

In the first microchannel 10, a dissolution step for dissolving the specific component in the solvent from the stock solution and extracting it is performed. Concretely, by supplying the stock solution and the solvent to the first microchannel 10, the stock solution and the solvent are joined within the first microchannel 10, and the joined stock solution and solvent flows within the first microchannel 10 in a state of a slag flow or a two layer flow. Although flow patterns of the liquid include a flow condition in emulsion except for such a slag flow or a two-layer flow, the slag flow and the two-layer flow are the flow conditions in which two different liquids are relatively easy to separate compared to emulsion in which one liquid is dispersed in the other liquid in a state of fine particles.

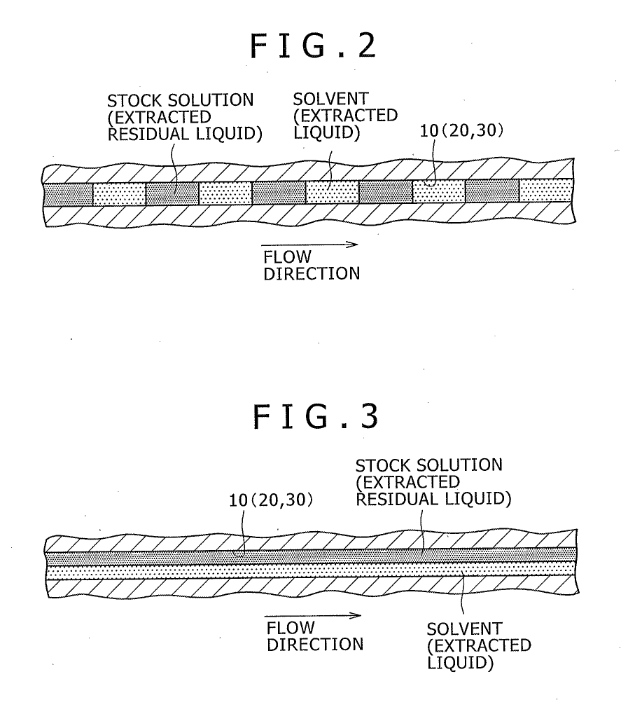

Concretely, as shown in FIG. 2, in the state of the slag flow, slag of the stock solution having minute length and slag of the solvent having minute length are arranged so as to be alternately aligned along the flow direction to flow. As shown in FIG. 3, in the state of the two-layer flow, the stock solution and the solvent are arranged in parallel along the flow direction and flow parallel to each other. Whether the stock solution and the solvent flow through the first microchannel 10 in the state of the slag flow or in the state of the two-layer flow depends on the supply flow rate of the stock solution and the solvent, the property such as viscosity, the equivalent diameter or the cross-sectional shape of the first microchannel 10, and other various factors. In the process in which the stock solution and the solvent flow to the downstream side through the first microchannel 10 in the state of the slag flow or the two-layer flow, the specific component to be the extraction object dissolves in the solvent from the stock solution via the interface between the stock solution and the solvent and the specific component is extracted. Thereby, the content of the specific component in the stock solution is lowered by the amount of the specific component extracted in the solvent.

Then, the extracted liquid comprising the solvent having extracted the specific component and the extracted residual liquid comprising the stock solution lowered in the content of the specific component are discharged from the outlet of the first microchannel 10 and introduced into the first settler 12. In the first settler 12, the separation step for separating the introduced liquid into the extracted liquid and the extracted residual liquid is performed. Concretely, the liquid introduced into the first settler 12 is separated by a specific gravity difference into the light fluid and the heavy fluid with a larger specific gravity than the light fluid. In the present embodiment, the extracted residual liquid corresponds to the light fluid and the extracted liquid corresponds to the heavy fluid. In the first settler 12, the light fluid floats on the upper side and the heavy fluid sinks on the lower side.

Next, from the first settler 12, the extracted residual liquid (light fluid) is led out to the first upper side leading path 15 and the extracted liquid (heavy fluid) is led out to the first lower side leading path 16 (the leading step).

On this occasion, the flow rate of the extracted residual liquid led out of the first settler 12 to the first upper side leading path 15 is controlled (the flow rate control step). Concretely, based on the data of the height position of the interface between the extracted residual liquid and the extracted liquid within the first settler 12 which was detected by the first liquid level gauge 14, the first control unit 40 regulates the opening of the first upper side valve 17 such that the height position of the interface is maintained between the height position of the connection part of the first upper side leading path 15 to the first settler 12 and the height position of the connection part of the first lower side leading path 16 to the first settler 12, thereby controlling the flow rate of the extracted residual liquid led out of the first settler 12 to the first upper side leading path 15. Specifically, for example, when the flow rate of the stock solution supplied from the first supply pump 1 is changed, flow ratio between the stock solution and the solvent is changed, so that the height position of the interface within the first settler 12 fluctuates. At this time, the first control unit 40 reduces the flow rate of the extracted residual liquid led out of the first settler 12 to the first upper side leading path 15 by reducing the opening of the first upper side valve 17 in a case where the height position of the interface detected by the first liquid level gauge 14 is raised, and increases the flow rate of the extracted residual liquid led out of the first settler 12 to the first upper side leading path 15 by enlarging the opening of the first upper side valve 17 in a case where the height position of the interface detected by the first liquid level gauge 14 is lowered. In this way, even if the supply flow rate of the stock solution is changed, the height position of the interface within the first settler 12 is maintained between the height position of the connection part of the first upper side leading path 15 and the height position of the connection part of the first lower side leading path 16.

Then, in the present embodiment, the extraction operation (separation operation) such as the above is repeated twice more. That is, in the present embodiment, the extraction operation is performed three times in total.

In the second extraction operation, the extracted residual liquid led out to the first upper side leading Path 15 is introduced into the inlet side of the second microchannel 20, and a new solvent is introduced into the inlet side of the second microchannel 20 from the second supply pump 2. Thereby, the extracted residual liquid separated in the first stage extraction operation and the new solvent flow through the second microchannel 20 in the state of the slag flow or the two-layer flow, and the specific component remaining in the extracted residual liquid is eluted in the new solvent and extracted. The extraction step (dissolution step) in the second microchannel 20 in the second extraction operation is similar to the extraction step (dissolution step) in the first microchannel 10 in the above-mentioned first extraction operation. Then, after that, in the second settler 22, the separation step similar to the above-mentioned separation step in the first settler 12 is performed, and the leading step for leading out the extracted residual liquid separated in the second settler 22 to the second upper side leading path 25 and leading out the extracted liquid to the second lower side leading path 26 is performed similarly to the leading step in the above-mentioned first extraction operation. Further, the flow rate of the extracted residual liquid to be led out to the second upper side leading path 25 is controlled similarly by the first control unit 40 based on the data of the height position of the interface between the extracted residual liquid and the extracted liquid detected by the second liquid level gauge 24.

Next, in the third extraction operation, the extracted residual liquid led out to the second upper side leading path 25 is introduced into the inlet side of the third microchannel 30, and a new solvent is supplied to the inlet side of the third microchannel 30 from the second supply pump 2. Thereby, in the third microchannel 30, the specific component is extracted in the new solvent from the extracted residual liquid in the same way as the extraction step (dissolution step) in the second microchannel 20. After that, in the same way as the second extraction operation, the separation step, the leading step, and the flow rate control step are performed, and then the final extracted residual liquid is led out through the third upper side leading path 35.

In the first embodiment, since the stock solution or the preceding stage extracted residual liquid and the solvent are fed in the state of the slag flow or the two-layer flow to the microchannels 10, 20, 30 at the dissolution steps of the respective extraction operations, the fluid introduced into the settlers 12, 22, 32 from the microchannels 10, 20, 30 can be separated into the solvent (extracted liquid) in which the specific component is dissolved and the remaining fluid (extracted residual liquid) in a short time at the subsequent separation step. Concretely, the extracted liquid and the extracted residual liquid flowing in the state of the slag flow or the two-layer flow is in a state that both liquids are relatively separated from each other, and therefore the fluid is easy to separate in the settlers 12, 22, 32 and can be separated into the extracted liquid in which the specific component is dissolved and the extracted residual liquid in a short time, compared with the case where the fluid is agitated and mixed in a conventional agitation tank and the fluid comes into emulsion. Therefore, the steps can be continuously performed without increasing the settlers in size in order to secure the separation time.

Moreover, in the first embodiment, the height position of the interface between the extracted residual liquid (light fluid) and the extracted liquid (heavy fluid) within the settlers 12, 22, 32 is maintained at the height position between the connection parts of the upper side leading paths 15, 25, 35 and the connection parts of the lower side leading paths 16, 26, 36 to the settlers 12, 22, 32 by the flow rate control of the extracted residual liquid led out of the settlers 12, 22, 32, and therefore it is possible to prevent one of the extracted residual liquid and the extracted liquid from being contaminated with the other and being led out of the settlers 12, 22, 32 to the upper side leading paths 15, 25, 35 or the lower side leading paths 16, 26, 36. That is, the extracted liquid in which the specific component is dissolved and the extracted residual liquid can be surely separated in the settlers 12, 22, 32 and led out. Then, since the extracted residual liquid and the extracted liquid led out of the settlers 12, 22, 32 can be prevented from being mutually contaminated by such a flow rate control of the extracted residual liquid, it is not necessary to increase the settlers 12, 22, 32 in size in order to secure the allowable width of the fluctuation in the height position of the interface between the extracted residual liquid and the extracted liquid within the settlers 12, 22, 32 to the flow rate change of the stock solution. Even from this viewpoint, the settlers 12, 22, 32 can be decreased in size, and thus the extraction device for use in the extraction method can be decreased in size.

Moreover, in the first embodiment, the extraction operations are performed repeatedly in three stages, at the dissolution step of the succeeding stage extraction operation, the extracted residual liquid led out at the leading step of the previous stage extraction operation is fed to the microchannels 20, 30, and the specific component remaining in the extracted residual liquid is dissolved in the new solvent. Since the solvent is lowered in its elution capacity (extraction capacity) as the amount of the extraction object component dissolved therein is increased, by dissolving the specific component in the stock solution or the preceding stage extracted residual liquid in the new solvent respectively at the dissolution steps of the respective stage extraction operations as thus described, the efficiency of elution can be improved. Therefore, a total time to be required for all steps of extraction can be shortened.

### Second Embodiment

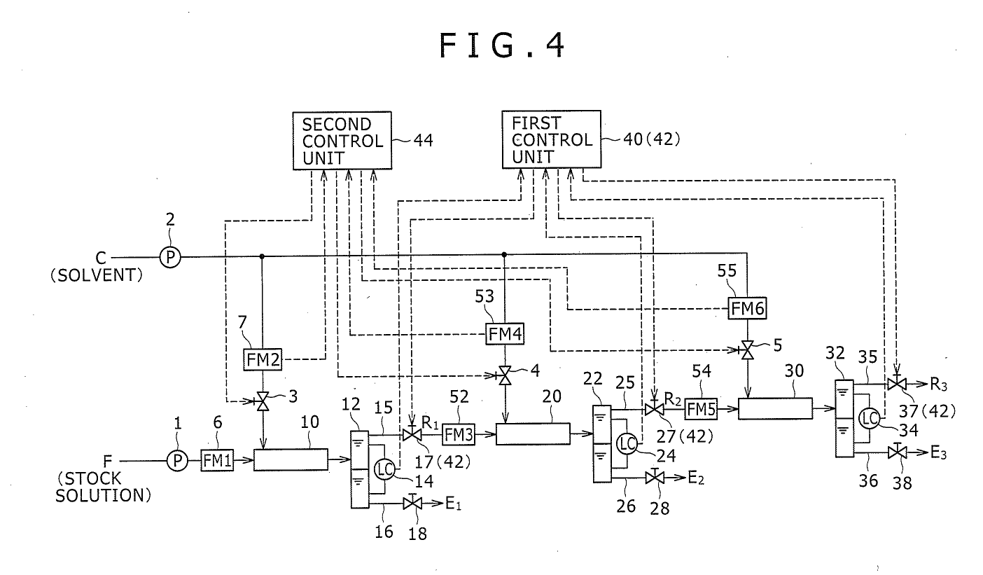

Next, with reference to FIG. 4, the extraction method as a second embodiment of the separation method of the present invention will be described. In the extraction method according to the second embodiment, unlike the above-mentioned extraction method according to the first embodiment, the flow rate of the extracted residual liquid led out of the settlers 12, 22, 32 of the respective extraction stages to the upper side leading paths 15, 25, 35 is controlled according to the flow rate of the stock solution or the extracted residual liquid introduced into the corresponding microchannels 10, 20, 30 of the extraction stages.

Concretely, in an extraction device for use in the extraction method according to the second embodiment, as shown in FIG. 4, the first upper side leading path 15 is provided with a third flow meter 52, and the branch pipe connected to the second microchannel 20 among the piping connected to the second supply pump 2 is provided with a fourth flow meter 53. Moreover, the second upper side leading path 25 is provided with a fifth flow meter 54, and the branch pipe connected to the third microchannel 30 among the piping connected to the second supply pump 2 is provided with a sixth flow meter 55. The third flow meter 52 detects a flow rate of the extracted residual liquid led out of the first settler 12 to the first upper side leading path 15 and supplied to the second microchannel 20, and the fourth flow meter 53 detects a flow rate of the solvent supplied from the second supply pump 2 to the second microchannel 20. Moreover, the fifth flow meter 54 detects a flow rate of the extracted residual liquid led out of the second settler 22 to the second upper side leading path 25 and supplied to the third microchannel 30, and the sixth flow meter 55 detects a flow rate of the solvent supplied from the second supply pump 2 to the third microchannel 30.

In addition, to the first control unit 40, data of the flow rate detected by the third flow meter 52 and the fifth flow meter 54 is sent. The first control unit 40 regulates the opening of the first upper side valve 17 based on the data of the supply flow rate of the stock solution from the first supply pump 1 detected by the first flow meter 6 and controls the flow rate of the extracted residual liquid led out of the first settler 12 to the first upper side leading path 15. Moreover, the first control unit 40 regulates the opening of the second upper side valve 27 based on the data of the flow rate of the extracted residual liquid to be led out of the first settler 12 to the first upper side leading path 15 detected by the third flow meter 52 and controls the flow rate of the extracted residual liquid led out of the second settler 22 to the second upper side leading path 25. Moreover, the first control unit 40 regulates the opening of the third upper side valve 37 based on the data of the flow rate of the extracted residual liquid to be led out of the second settler 22 to the second upper side leading path 25 detected by the fifth flow meter 54 and controls the flow rate of the extracted residual liquid led out of the third settler 32 to the third upper side leading path 35.

In addition, the second control unit 44 regulates the opening of the second solvent flow rate regulating valve 4 based on the data of the flow rate of the solvent detected by the fourth flow meter 53 and sets the flow rate of the solvent supplied to the second microchannel 20 to a set flow rate. Moreover, the second control unit 44 regulates the opening of the third solvent flow rate regulating valve 5 based on the data of the flow rate of the solvent detected by the sixth flow meter 55 and sets the flow rate of the solvent supplied to the third microchannel 30 to a set flow rate.

The configuration other than the above of the extraction device for use in the extraction method according to the second embodiment is similar to the configuration of the above-mentioned extraction device for use in the extraction method according to the first embodiment.

Then, in the extraction method according to the second embodiment, at the flow rate control step for the extracted residual liquid to be led out of the first settler 12 to the first upper side leading path 15, in a case where the supply flow rate of the stock solution increases and decreases, based on the data of the supply flow rate of the stock solution which was detected by the first flow meter 6, the first control unit 40 regulates the opening of the first upper side valve 17 such that the flow rate of the extracted residual liquid to be led out of the first settler 12 to the first upper side leading path 15 increases and decreases at the same rate as the increase/decrease rate of the supply flow rate of the stock solution, and controls the flow rate of the extracted residual liquid to be led out of the first settler 12 to the first upper side leading path 15. Thereby, the height position of the interface between the extracted residual liquid and the extracted liquid within the first settler 12 is maintained between the height position of the connection part of the first upper side leading path 15 to the first settler 12 and the height position of the connection part of the first lower side leading path 16 to the first settler 12.

Concretely, when the supply flow rate of the stock solution is increased, the amount of the extracted residual liquid introduced into the first settler 12 is increased and the height position of the interface is lowered, but the lowering of the interface is suppressed by increasing the flow rate of the extracted residual liquid to be led out of the first settler 12 to the first upper side leading path 15 at the same rate as the increasing rate of the supply flow rate of the stock solution, and the height position of the interface is maintained between the connection part of the first upper side leading path 15 and the connection part of the first lower side leading path 16. Moreover, in contrast, when the supply flow rate of the stock solution is decreased, the amount of the extracted residual liquid introduced into the first settler 12 is decreased and the height position of the interface is raised, but the rise of the interface is suppressed by decreasing the flow rate of the extracted residual liquid to be led out of the first settler 12 to the first upper side leading path 15 at the same rate as the decreasing rate of the supply flow rate of the stock solution, and the height position of the interface is maintained between the connection part of the first upper side leading path 15 and the connection part of the first lower side leading path 16.

In addition, at the flow rate control step for the extracted residual liquid led out of the second settler 22 to the second upper side leading path 25, in a case where the flow rate of the extracted residual liquid to be led out increases and decreases, based on the data of the flow rate of the extracted residual liquid to be led out of the first settler 12 to the first upper side leading path 15 (the flow rate of the extracted residual liquid to be introduced into the second microchannel 20) which was detected by the third flow meter 52, the first control unit 40 regulates the opening of the second upper side valve 27 such that the flow rate of the extracted residual liquid to be led out of the second settler 22 to the second upper side leading path 25 increases and decreases at the same rate as the increase/decrease rate of the flow rate of the extracted residual liquid to be led out of the first settler 12 to the first upper side leading path 15, and controls the flow rate of the extracted residual liquid to be led out of the second settler 22 to the second upper side leading path 25. Thereby, as with the case of the first settler 12 described above, the height position of the interface between the extracted residual liquid and the extracted liquid within the second settler 22 is maintained between the height position of the connection part of the second upper side leading path 25 to the second settler 22 and the height position of the connection part of the second lower side leading path 26 to the second settler 22.

Moreover, at the flow rate control step for the extracted residual liquid led out of the third settler 32 to the third upper side leading path 35, based on the data of the flow rate of the extracted residual liquid to be led out of the second settler 22 to the second upper side leading path 25 (the flow rate of the extracted residual liquid to be introduced into the third microchannel 30) which was detected by the fifth flow meter 54, as with the above, the first control unit 40 regulates the opening of the third upper side valve 37 and controls the flow rate of the extracted residual liquid to be led out of the third settler 32 to the third upper side leading path 35. Thereby, as with the above, the height position of the interface between the extracted residual liquid and the extracted liquid within the third settler 32 is maintained between the height position of the connection part of the third upper side leading path 35 to the third settler 32 and the height position of the connection part of the third lower side leading path 36 to the third settler 32.

The configuration other than the above of the extraction method according to the second embodiment is similar to the above-mentioned extraction method according to the first embodiment. According to the second embodiment, the same effect as the above-mentioned first embodiment can be obtained.

### Third Embodiment

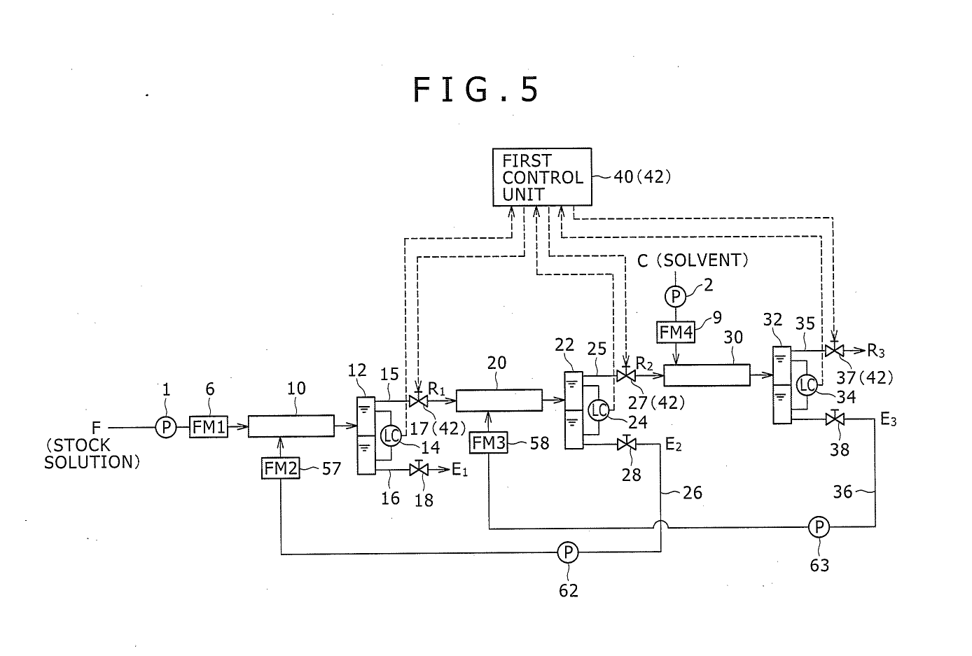

Next, with reference to FIG. 5, the extraction method as a third embodiment of the separation method of the present invention will be described. In the extraction method according to the third embodiment, at the extraction step (dissolution step) of the preceding stage extraction operation, the extracted liquid led out to the lower side leading path 26 (36) at the leading step of the following stage extraction operation is fed to the preceding stage microchannel 10 (20) as a solvent.

Concretely, in an extraction device for use in the extraction method according to the third embodiment, as shown in FIG. 5, the second lower side leading path 26 is connected to the inlet side of the first microchannel 10, and the third lower side leading path 36 is connected to the inlet side of the second microchannel 20. Moreover, the second lower side leading path 26 is provided with a first returning pump 62 and a second flow meter 57, and the third lower side leading path 36 is provided with a second returning pump 63 and a third flow meter 58. In addition, the piping connected to the second supply pump 2 does not branch, and is connected to the inlet side of the third microchannel 30. The piping connecting the second supply pump 2 to the third microchannel 30 is provided with the fourth flow meter 9. Moreover, in the third embodiment, the configuration for supplying the new solvent to the first microchannel 10 and the second microchannel 20 and the second control unit 44 are not provided. The configuration other than the above of the extraction device for use in the extraction method of the third embodiment is similar to the configuration of the above-mentioned extraction device for use in the extraction method of the first embodiment.

Then, in the extraction method of the third embodiment, the extracted liquid (heavy fluid) led out of the second settler 22 to the second lower side leading path 26 at the leading step of the second stage extraction operation is delivered by the first returning pump 62 and is introduced into the first microchannel 10 as the solvent at the extraction step (dissolution step) of the first stage extraction operation. Moreover, in the extraction method of the third embodiment, the extracted liquid (heavy fluid) led out of the third settler 32 to the third lower side leading path 36 at the leading step of the third stage extraction operation is delivered by the second returning pump 63 and is introduced into the second microchannel 20 as the solvent at the extraction step (dissolution step) of the second stage extraction operation.

The configuration other than the above of the extraction method according to the third embodiment is similar to the above-mentioned extraction method according to the first embodiment.

In the third embodiment, since the extracted liquid comprising the solvent in which the specific component was dissolved at the dissolution step of the succeeding stage extraction operation is led out of the settler 22 (32) at the same stage leading step, and can be reused as the solvent used at the extraction step (dissolution step) of the previous stage extraction operation, the amount of the solvent used can be reduced.

In addition, while the extracted liquid led out of the second settler 22 at the leading step of the second stage extraction operation is the solvent in which the specific component to be the extraction object was dissolved, the first stage extracted residual liquid to be the object fluid of the second stage extraction operation is lowered in the content of the specific component compared to the stock solution, so the amount of the specific component dissolved in the extracted liquid (solvent) in the second stage extraction operation is decreased compared with the case of the extracted liquid of the first stage extraction operation. Therefore, even if the extracted liquid led out of the second settler 22 is used as the solvent at the extraction step (dissolution step) for the stock solution having a high content of the specific component in the first stage extraction operation, the specific component can be sufficiently eluted and extracted from the stock solution having a high content of the specific component. Moreover, the same thing can be said about the extracted liquid which is led out of the third settler 32 at the leading step of the third stage extraction operation and Introduced into the second microchannel 20 as the solvent for the second stage extraction operation.

The effects obtained by the third embodiment other than the above are similar to the above-mentioned effects obtained by the first embodiment.

Note that the embodiments disclosed herein are to be considered in all the respects as illustrative and not restrictive. The scope of this invention is indicated not by the aforementioned description of embodiments but by the claims, and it is intended that all changes within the equivalent meaning and scope to the claims may be included therein.

For example, in the above-mentioned embodiments, although the object fluid and the solvent are both liquids, one of the object fluid and the solvent may be gas.

Moreover, in the above-mentioned embodiments, the opening of the upper side valve is regulated and the flow rate of the light fluid (extracted residual liquid) led out of the settler to the upper side leading path is controlled. Instead, by regulating the opening of the lower side valve and controlling the flow rate of the heavy fluid led out of the settler to the lower side leading path, the height position of the interface between the light fluid and the heavy fluid within the settler may be maintained between the height position of the connection part of the upper side leading path and the height position of the connection part of the lower side leading path to the settler. In this case, the flow rate control device is configured by the first control unit and the respective lower side valves.

Moreover, by controlling the flow rate of the light fluid led out to the upper side leading path with the upper side valve and controlling the flow rate of the heavy fluid led out to the lower side leading path with the lower side valve, the height position of the interface may be maintained between the height position of the connection part of the upper side leading path and the height position of the connection part of the lower side leading path. In this case, the flow rate control device is configured by the first control unit and the respective upper side valves and lower side valves.

In addition, the light fluid may be the extracted liquid and the heavy fluid may be the extracted residual liquid. In this case, the preceding stage lower side leading path will be connected to the succeeding stage microchannel, and the extracted residual liquid led out of the preceding stage settler to the lower side leading path will be introduced into the succeeding stage microchannel. Then, in this case, the flow rate of the extracted residual liquid led out of the settler to the lower side leading path will be controlled with the lower side valve.

Moreover, in the above-mentioned second embodiment, the first control unit may regulate the opening of the first upper side valve based on both data of the supply flow rate of the stock solution detected by the first flow meter and the supply flow rate of the solvent detected by the second flow meter, thereby controlling the flow rate of the extracted residual liquid led out of the first settler to the first upper side leading path. Also at the flow rate control steps of the second stage and third stage extraction operations, similar flow rate control may be performed.

Moreover, in the above-mentioned embodiments, although the extraction method as an example of the separation method is described, the present invention is not limited to such an extraction method. Other forms of the separation method of the present invention include an absorption method for dissolving and absorbing a specific component in a solvent from the object fluid, for example. The present invention can be applied to such an absorption method, and the above⁻mentioned extraction device can be used as an absorption device for implementing the absorption method. It should be noted that the absorption device is included in the concept of “separation device” of the present invention. In the absorption method, for example, gas containing CO₂ as the specific component is used as the object fluid, and CO₂ is absorbed in water as the solvent from the object fluid. In this case, the solvent (water) having absorbed the specific component becomes the heavy fluid, and gas as the object fluid from which the specific component (CO₂) has been absorbed becomes the light fluid. In addition, in the absorption method using the object fluid and the solvent other than such an example, in a case where the solvent having absorbed the specific component becomes the light fluid and the object fluid from which the specific component has been absorbed becomes the heavy fluid, the preceding stage lower side leading path will be connected to the succeeding stage microchannel, and the heavy fluid led out of the preceding stage settler to the lower side leading path will be introduced into the succeeding stage microchannel.

In the above-mentioned third embodiment, although the configuration of the above-mentioned first embodiment is modified in such a manner that the succeeding stage extracted residual liquid is introduced into the preceding microchannel as the solvent, the configuration of the above-mentioned second embodiment may be modified similarly.

Moreover, in the respective embodiments described above, although the mode in which the extraction operations are performed in three stages is described, the present invention is not limited thereto. That is, the present invention can be applied to the extraction method (separation method) and the extraction device (separation device) in which the extraction operations are performed in one stage only, in two stages, or in four stages or more.

In addition, the first to third upper side valves described above may be provided with the control units for regulating the opening of the valve one by one, and the respective control units may regulate the opening of the corresponding valves based on the data from the corresponding liquid level gauges or the data from the corresponding flow meters. In this case, the first control unit does not need to be provided. Similarly, the first to third solvent flow rate regulating valves may be provided with the control units for regulating the opening of the valve one by one, and the respective control units may regulate the opening of the corresponding valves based on the data from the corresponding flow meters. In this case, the second control unit does not need to be provided.

What is claimed is:

1. A separation method for separating a specific component from the object fluid by dissolving the specific component in a solvent from the object fluid containing the specific component, comprising the steps of:
dissolving the specific component in the solvent from the object fluid within microchannels by feeding the object fluid and the solvent in a state of a slag flow or a two-layer flow to the microchannels;
introducing the fluid discharged from the microchannels into settlers and separating the fluid into a fluid comprising the solvent in which the specific component is dissolved and a remaining fluid by a specific gravity difference within the settlers;
leading a light fluid which is one fluid with a smaller specific gravity among the fluid in which the specific component is dissolved and the remaining fluid out of the settlers through upper side leading paths connected to the settlers and leading a heavy fluid which is one fluid with a larger specific gravity among the fluid in which the specific component is dissolved and the remaining fluid out of the settlers through lower side leading paths connected to the settlers at a position lower than connection parts of the upper side leading paths to the settlers; and
controlling at least one flow rate of a flow rate of the light fluid led out of the settlers to the upper side leading paths and a flow rate of the heavy fluid led out of the settlers to the lower side leading paths such that the height position of an interface between the light fluid and the heavy fluid within the settlers is maintained between the height position of the connection parts of the upper side leading paths to the settlers and the height position of connection parts of the lower side leading paths to the settlers.

2. The separation method according to claim 1, wherein
a separation operation including the dissolution step, the separation step, the leading step, and the flow rate control step is repeatedly performed a plurality of times, and
in the dissolution step of the succeeding stage separation operation among the plurality of separation operations, the fluid corresponding to the remaining fluid among the light fluid led out to the upper side leading path and the heavy fluid led out to the lower side leading path at the leading step of the previous separation operation is fed to the microchannel as the object fluid and the specific component remaining in the fluid is dissolved in the solvent.

3. The separation method according to claim 2, wherein
in the separation step of the specific separation operation among the plurality of separation operations, the fluid corresponding to the fluid in which the specific component is dissolved among the light fluid led out to the upper side leading path and the heavy fluid led out to the lower side leading path at the leading step of the following separation operation is fed to the microchannel as the solvent.

4. A separation device for separating a specific component from the object fluid by dissolving the specific component in a solvent from the object fluid containing the specific component, comprising:
microchannels for feeding the object fluid and the solvent in a state of a slag flow or a two-layer flow and dissolving the specific component in the solvent from the object fluid;
settlers connected to the microchannels so as to introduce the fluid discharged from the microchannels therein for separating the fluid discharged from the microchannels into a fluid comprising the solvent in which the specific component is dissolved and a remaining fluid by a specific gravity difference;
upper side leading paths connected to the settlers for leading a light fluid which is one fluid with a smaller specific gravity among the fluid in which the specific component is dissolved and the remaining fluid out of the settlers;
lower side leading paths connected to the settlers at a position lower than connection parts of the upper side leading paths to the settlers for leading a heavy fluid which is one fluid with a larger specific gravity among the fluid in which the specific component is dissolved and the remaining fluid out of the settlers; and
a flow rate control device for controlling at least one flow rate of a flow rate of the light fluid led out of the settlers to the upper side leading paths and a flow rate of the heavy fluid led out of the settlers to the lower side leading paths such that the height position of an interface between the light fluid and the heavy fluid within the settlers is maintained between the height position of the connection part of the upper side leading paths to the settlers and the height position of connection parts of the lower side leading paths to the settlers.
